(19) United States
(12) Patent Application Publication
(10) Pub. No.: US 2007/0101004 A1
(43) Pub. Date: May 3, 2007

(54) Internet protocol telephone system

(76) Inventor: Rich Loen, Ottawa (CA)

Correspondence Address: TEITELBAUM & MACLEAN, 280 SUNNYSIDE AVENUE, OTTAWA, ON, K1S 0R8, CA

(21) Appl. No.: 11/476,810

(22) Filed: Jun. 29, 2006

Related U.S. Application Data
(60) Provisional application No. 60/695,186, filed on Jun. 30, 2005.

(51) Int. Cl. G06F 15/16

(52) U.S. Cl. 709/227

(57) ABSTRACT

A telephone system that can be controlled by graphical user interfaces (GUIs) displayed using a graphical page description language (GPDL), e.g. HTML, on a touch-sensitive display screen provided with the telephone. An application program interface (API) enables a commonly available user interface tool, e.g. Microsoft Front Page, to program any number of telephone functions for display and access via the GUIs on the display screen. Since the GUIs are downloaded from a server connected to the internet, the pages displayed on the display screen can be varied according to personal preference or according to temporal and/or geographical criteria, e.g. advertisements can be sent depending on the time or day, month or year to telephones depending on their location (houses, apartments, hotels).

### CROSS-REFERENCE TO RELATED APPLICATIONS

The present invention claims priority from U.S. Patent Application No. 60/695,186 filed Jun. 30, 2005, which is incorporated herein by reference for all purposes.

### TECHNICAL FIELD

The present invention relates to an internet protocol (IP) telephone system, and in particular to an interactive IP telephone system providing an end user with the ability to control a telephone and respond to telephony events utilizing a graphical page description language, such as hyper-text markup language (HTML).

### BACKGROUND OF THE INVENTION

With the growth in popularity in the internet, and specifically internet commerce, telephone manufacturers have decided to provide another portal to the internet by providing internet connected display phones. Unfortunately, conventional telephone manufacturers still “hardwire” all of the telephone functions into each telephone providing very little, if any, flexibility in telephone functions and internet access. Accordingly, each phone must be manufactured with predetermined applications for a specific customer or with a set of predetermined applications that are designed to suite as many customers as possible. Moreover, the manufacturers must rely on scarce firmware engineers rather than more prevalent software engineers. To stay competitive modern telephone manufacturers require a method of testing, demonstrating and deploying applications rapidly and inexpensively.

Advertisements for restaurants and other service industries, in the form of pamphlets or coupons, have become common place in the mail and, in particular, in hotel rooms where advertisements are particularly influential on people unfamiliar with local establishments. Hotels have gone so far as to provide a television channel dedicated to advertising local establishments. Internet advertising has also become common place, as almost all “free” websites have some form of advertising or direct links to sponsors. Typically, internet advertising is in response to a search initiated by the user, so the time and accessibility of the advertisement is usually out of the control of the advertiser.

An object of the present invention is to overcome the shortcomings of the prior art by providing an internet telephone system that enables control of telephone functionality using a graphical page description language, e.g. HTML, and accordingly enables a variety of telephone related applications to be added by the customer.

### SUMMARY OF THE INVENTION

Accordingly, the present invention relates to a telephone comprising:

a telephone housing including a microphone, a speaker, a telephony service provider (TSP), telephone hardware for sending and receiving telephone calls, and a display screen;

a processor with memory for running a player, which utilizes a graphical page description language to display pages, including graphical user interfaces (GUIs) relating to telephone control, accessed from the internet or from content stored in memory on the display screen; and

an application programming interface (API) enabling the graphical user interfaces to interact with the TSP to control the telephone hardware for controlling the sending and receiving of telephone calls, whereby various combinations of telephone applications are displayable on the display screen and controllable therethrough.

### BRIEF DESCRIPTION OF THE DRAWINGS

The invention will be described in greater detail with reference to the accompanying drawings which represent preferred embodiments thereof, wherein:

FIG. 1 illustrates a telephone according to the present invention;

FIG. 2 is a schematic view of a telephone system according to the present invention;

FIG. 3 is a schematic view of a telephone system according to another embodiment of the present invention providing interactive advertising.

### DETAILED DESCRIPTION

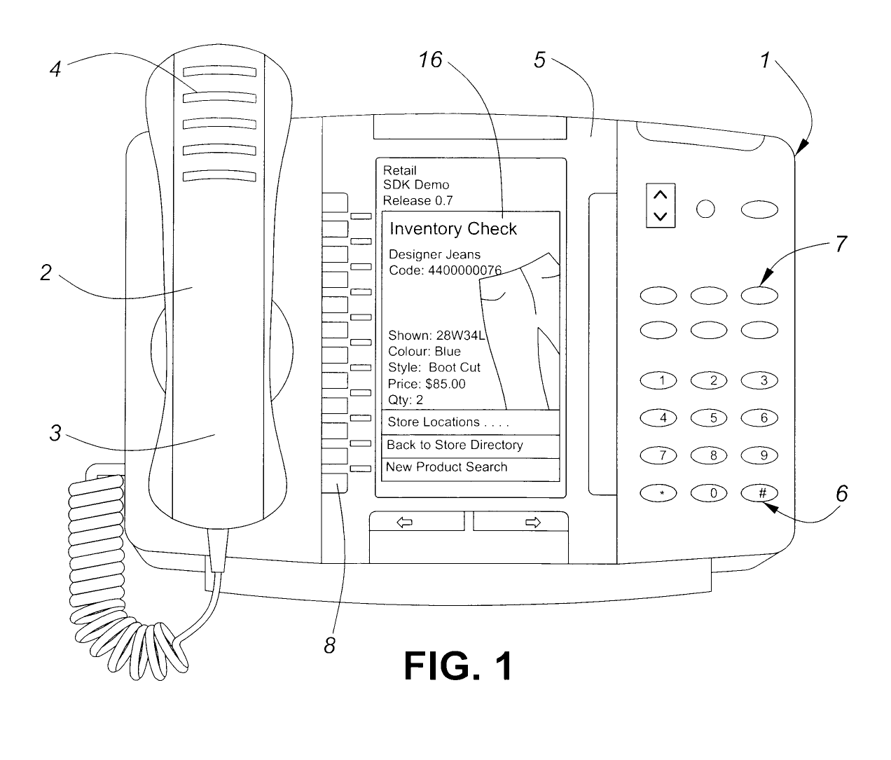

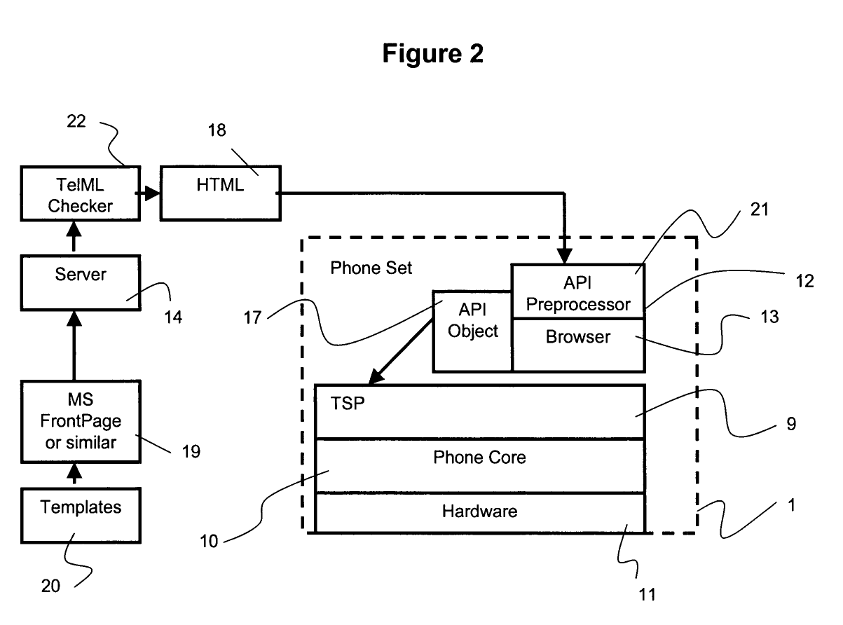

With reference to FIGS. 1 and 2, a telephone 1 according to the present invention includes the standard features of a conventional telephone, i.e. a handheld receiver 2 with a microphone 3 and a speaker 4 mounted on a housing 5, which optionally includes a numeric keypad 6, a specialty function keypad 7, and an array of memory keys 8. The specialty function keypad 7 can include control for extra telephone functions, e.g. hold, mailbox access, call forwarding, record message, speaker phone, volume, mute, headset etc. The memory keys 8 can provide one number dialing for a plurality of frequently used telephone numbers stored in memory. With reference to FIG. 2, the telephone 1 also includes a standard telephony service provider (TSP) 9, a phone core 10, and hardware 11 enabling telephone signals to be sent and received over a standard telephone line or a standard internet protocol (IP) line.

A computer processor 12 with sufficient memory is provided within the housing 5 for supporting a player 13, such as a standard web browser, e.g. Internet Explorer, for connection to the internet via a server 14. The player 13 utilizes a graphical page description language (GPDL), e.g. hyper-text markup language (HTML), to generate graphical user interfaces (GUIs) for display on a touch sensitive display screen 16, provided on the housing 5. Each phone 1 is configured to normally display a homepage, which can include a GUI representation of a telephone touch pad, and/or a collection of recently received telephone numbers and/or a collection of recently dialed telephone numbers and/or a collection of frequently used telephone numbers and/or a collection of emergency telephone numbers and/or a collection of company telephone numbers and/or GUI representations of buttons or tabs linked to pages containing any or all of the previously mentioned collections. The collections of telephone numbers can be provided by the retailer of the phone or prepared by the user. In particular, the personal collection of frequently used telephone numbers can be saved from one of the other collections or input directly using the keypad 6. The URL of the homepage as well as some or all of the collection data, can be saved in the memory supplied in the telephone 1. The homepage and the additional pages can also be saved in the telephone's memory. Alternatively, the homepage, the additional pages and some or all of the collection data can be save in the server 14 accessible via their URLs. Telephone inputs are initiated by pressing on the display screen 16 over or proximate the GUI corresponding to the desired telephone number.

Searches can be performed using the player 13 via the display screen 16 in combination with some form of key pad entry 6, 7 or 8. The searches can be of the entire internet using any one of the available search engines, e.g. Google, or of specially prepared databases saved on the server 14 or associated memory locations. Results of the searches are displayed on the display screen 16 with a corresponding phone number displayed in a GUI, whereby pressing on the display screen 16 on the telephone number GUI initiates a telephone input.

An application program interface (API) 17 converts the inputs from the display screen 16 into control signals for the TSP 9, whereby incoming and outgoing telephone calls can be initiated and/or controlled via the display screen 16. The API 17 is a set of software functions, variables, methods and events, which add telephony control functionality to a GPDL 18, such as HTML. Accordingly, a user of the GPDL can use commonly available user interface tools, e.g. Microsoft Front Page, at a remote computer terminal 19 linked to the server 14 to construct graphical telephone interfaces from scratch or using predetermined templates 20 that control a telephone and respond to telephony events, e.g. an incoming telephone call. The API 17 can also be defined as a series of pseudo code software classes and objects, which can be implemented in a number of languages, e.g. Java®, Javascript®, C®, and C++®. The API 17 can be implemented on existing telephone software or on an existing operating system, e.g. Windows, to extend the capabilities of a conventional internet browser, or it can be implemented on a stand alone player, which has no conventional or third party software.

Accordingly, the homepage and any other pages linked thereto can be designed and stored at a remote location, and accessed via the internet using their corresponding URLs. Any number of telephones can have the same homepage and linked pages, whereby entire hotels, companies, neighborhoods and cities can have a homepage designed specifically for them by a software designer familiar with a GPDL User Interface Tool. Moreover, every homeowner can tailor their phone to their specific needs and desires by themselves or for a minimal programming charge.

A pre-processor 21 may be provided in the telephone 1, for intercepting and processing the GPDL pages coming from the server 14 to ensure that each page is approved for playing on the telephone 1, and/or that each page is going to an approved telephone 1. Furthermore, the pre-processor 21 may also decrypt encrypted pages and/or decompress pages that have been subjected to compression.

One way to provide a security feature to a GPDL page is to add a URL lock, which is a mechanism that enables the player 13 to verify that the page must be coming from a specific URL or domain. An application manager 22 is provided at the server 14 for encrypting an approved URL and adding it to the GPDL page. The telephone 1 has a setting, which when enabled ensures that only pages that are appropriately locked are loaded. Page signatures are another way to provide a security feature to a GPDL page. Page signatures ensure that the GPDL page was encoded for a particular telephone switch, e.g. users PBX switch or web server, and that the switch will not play back pages that do not have the signature. The GPDL pages can also be encrypted to ensure that the content is not visible to players without the corresponding decryption key.

A certificate mechanism can also be utilized in which the telephone manufacturer provides the customer with a certificate, with which the customer then signs and encrypts the GPDL pages. The telephone pre-processor 21 can then verify and decrypt the GPDL pages and display the contents.

The telephone 1 sends events via the TSP 8 to the API 17 through an event object. The event object defines a number of events, and for each object, the user of the API 17 can specify the software, e.g. Javascript, code to run when the event occurs. The software code can be as simple as a function call or it can be a series of software statements that handle and process the event. Parameters for each event are accessed through a set of variables defined in the object. Only one event can be sent to the API 17 at a time, so the parameters do not interfere with each other.

Examples of Events, their corresponding parameters and their descriptions are detailed in the following table:

| Event | Parameter(s) | Description |
|---|---|---|
| BackInService | | Phone is back in service. |
| ButtonInformation | ButtonIndex | The programming on a button has been |
| | | changed-either by the API or some |
| | | external means (manually on the phone, or |
| | | through the switch) |
| ButtonPress | ButtonIndex | A button has been pressed. |
| CallProgressToneDetected | | Call progress tone detected. Only |
| | | works on outgoing calls. |
| | | Tones are: |
| | | 1 = dial tone |
| | | 2 = Stutter dial tone |
| | | 3 = line busy |
| | | 4 = Ring Back |
| CallWaitingDetected | CLIDName, | CLID may or may not be provided. This |
| | CLIDNumber, | event may occur more than once for the |
| | CLIDRaw, | same call. |
| | CLIDDateTime | |
| CLID | CLIDName, | If CLID is not provided with the Delivered |
| | CLIDNumber, | event, then it may be provided via this |
| | CLIDRaw, | event, which may come later. |
| | CLIDDateTime | |
| Conferenced | LineIndex | A conference has been created |
| ConnectionCleared | LineIndex | A call has been terminated |
| CPULoadError | | The CPU cannot keep up with the current |
| | | load-audio quality or phone functionality |
| | | may be affected. The API should scale |
| | | back CPU usage if possible. |
| Delivered | LineIndex, | An incoming call is occurring (CLID |
| | [symbol] | [symbol] |
| | CLIDName, | comes in this event). On an analog line, |
| | CLIDNumber, | CLID may not come with this event, but |
| | CLIDRaw, | may come later in the CLID event. |
| | CLIDDateTime | |
| DisplayChanged | | The virtual text display managed by the |
| | | switch or phone hardware has changed |
| | | content. When this event occurs, the API |
| | | user should read the display contents using |
| | | the TextDisplayObject and update the text |
| | | display region on screen, if this is being |
| | | user. |
| DNChanged | | Phone's DN has changed (generally means |
| | | user has changed hot-desk setting) |
| DoNotDisturb | | DND has been enabled or disabled. |
| DTMF | DTMF | A DTMF Tone was detected on the line. |
| ErrorCode | ErrorID, ErrorString | An error has occurred |
| Established | LineIndex | A call has been established |
| ExtensionInUse | | An extension is in use on the same phone |
| | | line. Analog phones only. |
| Failed | LineIndex | A call has failed (busy for instance) |
| Forwarding | LineIndex | A line is forwarded, or is no longer |
| | | forwarded. |
| HandsetCharging | | A handset is now charging on the base, or |
| | | has been removed from the base. Check the |
| | | handset collection for details. |
| HandsetNameChanged | HandsetIndex | The name of a handset has changed. |
| HandsetPredial | HandsetIndex | A handset has pre-dialed a number and the |
| | | call should now be connected. |
| Held | LineIndex | A call has been held |
| HoldRelease | | A call which was on hold on the base |
| | | phone has been picked up by an extension. |
| | | When this event is received, the base phone |
| | | should release the call. |
| Hookswitch | Hookswitch | Hookswitch has changed state. |
| IntercomCall | | An intercom call has started. |
| IntercomEnd | | An intercom call has ended. |
| IntercomPage | | An intercom page is occurring. |
| IntercomReject | | An intercom page has been rejected. |
| IntercomTimeout | | An intercom page has timed out. |
| LampMode | LampIndex, | A lamp has changed state (on, off, flashing) |
| | LampMode | |
| LanguageChanged | Language | The phone's language has been changed |
| | | through some means. |
| LineInUse | | The phone line is in use by either the base |
| | | or an extension phone. Analog phones |
| | | only. |
| LineStateChanged | LineIndex, | 0 = Idle, |
| | LineState | 1 = Dialtone, |
| | | 2 = Dialing, |
| | | 3 = Connected, |
| | | 4 = On Hold, |
| | | 5 = Incoming Ring |
| MemoryError | | The phone is running low on memory. |
| MessageWaiting | LineIndex | The message waiting lamp has changed |
| | | state. |
| MicStateChanged | | The phone's mic has changed state. |
| NetworkReached | LineIndex | The telephone network has been reached |
| | | and event reporting may be reduced. |
| Originated | LineIndex | A call has been originated. May be that |
| | | user dialed out manually. |
| OutOfService | | Phone is out of service (loading new info |
| | | through SAC link) |
| RegistrationAborted | | |
| RegistrationComplete | | |
| RegistrationDeleted | | |
| RegistrationStarted | | |
| Retrieved | LineIndex | A call has been retrieved from hold. |
| RingDetected | LineIndex, | Ring detected on line. Ring type is |
| | RingType | returned-ring type is 1, 2, 3, 4. |
| | | Ring 1 = RING1 standard ring 2 sec |
| | | on, 4 sec off. |
| | | Ring 2 = RING2 = 1st distinctive |
| | | pattern = (long, long), (short, short), |
| | | (short, long),(long, short) |
| | | Ring 3 = RING3 = 2nd distinctive |
| | | pattern = (short, long, short), (long, |
| | | short, long), (short, short, long) |
| | | Ring 4 = RING4 = Long Distance |
| | | pattern = (long, short, short) |
| | | Repeats for each ring, starting with second |
| | | ring. One ring cycle is required to detect |
| | | the ring type. |
| RingOff | LineIndex | A ring has started on the specified line. |
| | | This event follows the ring cadence for |
| | | distinctive rings. You may receive multiple |
| | | RING_ON and RING_OFF events during a |
| | | single ring cycle. |
| RingOn | LineIndex | A ring has started on the specified line. |
| | | This event follows the ring cadence for |
| | | distinctive rings. You may receive multiple |
| | | RING_ON and RING_OFF events during a |
| | | single ring cycle. |
| RingStarted | LineIndex | Occurs when a ring begins on a line. We |
| | | have not yet detected the ring type, but are |
| | | letting TelML know that a ring is |
| | | happening right now. Occurs at the start of |
| | | the first ring. Does not repeat |
| ServiceInitiated | LineIndex | An outgoing call has been started-it's at |
| | | dialtone state. |
| TransferCall | | |
| Transferred | LineIndex | A call has been transferred. |
| TransferReject | | |
| TransferTimeout | | |
| Voicemail Waiting | | |
| XMLHTTPRequest | XMLHTTPRequest | A response to an XMLHTTPRequest has |
| | | arrived and has been stored in the |
| | | XMLHTTPRequest variable. |

Details of the Event Parameters are listed below:

ButtonIndex: When button events occur, this parameter provides the index into the ButtonCollection for the button that was pressed.

CLIDName: The CLID name is provided here. If some other message is passed in CLID, such as “Unknown Caller” or “Private Number” this will be in this parameter.

CLIDNumber: The phone number of the caller. This should be a dialable number.

CLIDDateTime: The date and time of the call.

CLIDRaw: The raw CLID data.

DTMF: A DTMF Tone was detected.

0=“0” pressed on phone. 1=“1” pressed on phone. 2=“2” pressed on phone. 3=“3” pressed on phone. 4=“4” pressed on phone. 5=“5” pressed on phone. 6=“6” pressed on phone. 7=“7” pressed on phone. 8=“8” pressed on phone. 9=“9” pressed on phone. 10=“*” pressed on phone. 11=“#” pressed on phone.

ErrorID: A numeric error number.

ErrorString: A string description of the error.

HandsetIndex: The index in the handset collection of the handset.

Hookswitch: State of the hookswitch.

LampID: The index in the lamp collection of the lamp.

LampMode: The new mode for the lamp. Lamp modes are defined in the LampCollection.

LineIndex: The index in the LineCollection indicating the line that the event pertains to.

LineState: The line state as defined in the Lines Collection.

RingType: The detected Ring Type. Generally used for analog phones only.

XMLHTTPRequest: The data that has been returned as a result of the XMLHTTPRequest.

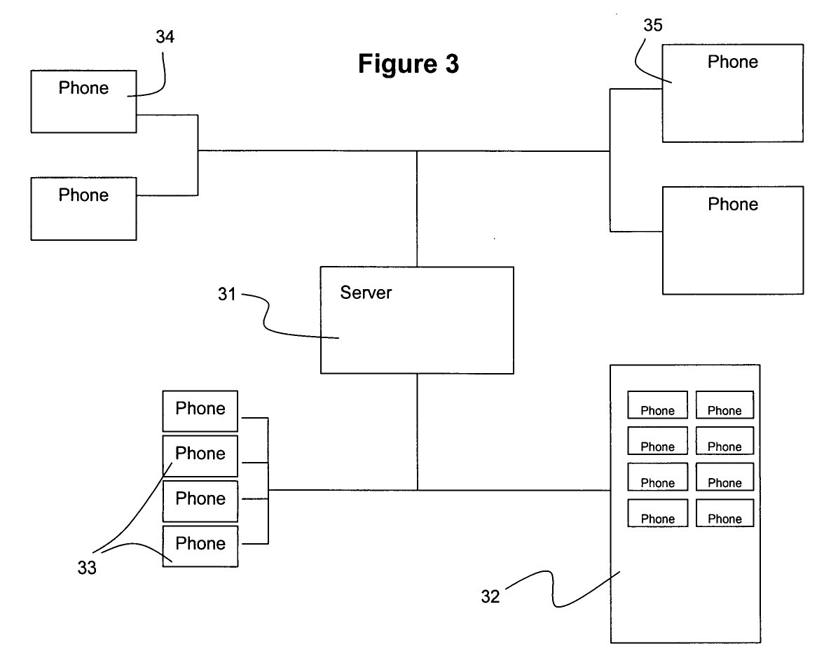

With reference to FIG. 3, the present invention can also be used in a system that provides interactive advertisements via the internet to the display screen 16 of each telephone 1. Various advertisers will store their advertisements on one or more centralized servers 31 for transmission to the telephones 1 of end users, wherein the players will interpret the advertisement page and display it on the display screen 16. The transmitted advertisements can be determined based on the geographical location of the telephones and on temporal criteria. For example, in a urban or suburban community advertisements relating to fast food restaurants will be transmitted in the late afternoon and early evening, while grocery store advertisements will be transmitted in the early morning. Real estate advertisements can be sent to telephones in apartment buildings 32 or town homes 33, while hardware or home improvement store advertisements will be transmitted only to single family homes 34 on Thursday, Friday and Saturday. High end automobile advertisements could be sent to homes 36 on certain streets or areas in which real estate prices are known to be high.

The present invention is particularly suited for use in hotels and hotel chains, in which the advertisements can be tailored to time of day and to specific rooms or groups of rooms, e.g. advertisements for breakfast specials in the hotel restaurant and for local attractions in the morning, advertisements for local fast food restaurants at lunch, and advertisements for local entertainment in the afternoon and evening. Moreover, advertisements for fine dining establishments and spa visits can be restricted to suites and the more expensive rooms. Some advertisements can be designed for every hotel in a chain of hotels, e.g. hotel restaurants and services, nationally run advertisements, while other advertisements will be specific to the geographical location of the hotel, e.g. local restaurants and attractions. Hotel facilities, such as housekeeping, room service, check out and spa, can all be advertised on the display screen 16 with tabs providing a direct telephone link thereto. The display screen 16 can also be personalized according to accommodate specific individuals or groups of people with information and links specific thereto, e.g. convention schedules, local maps to destinations, selected menu according to predetermined requirements, and special prices associated particular therewith.

Each advertisement can include a GUI representation of a button or tab with a phone number, which when pushed initiates a telephone call, as hereinbefore described, to the advertiser or a representative thereof. In addition, each advertisement can include links to related pages with additional information about the advertiser in any reasonable form, e.g. GUI, pictures, audio, and video or any combination thereof. Alternatively, the processor 12 and the API 17 can recognize telephone numbers in the advertisements, and convert them to telephone links for initiating a telephone call.

Each telephone 1, i.e. utilizing the processor 12 and the API 17, can also be programmed to provide a user defined home page with different functions displayed thereon or links to specific pages predetermined by the user. The linked pages can be conventional internet search, stock, news or weather webpages, e.g. Google, Yahoo, NASDAQ, and The Weather Network, or they can be customized GPDL pages stored on the server 14 or in the memory of processor 12, which access up-to-date information from the internet and displayed in a way designed by the user. Weather forecasts specific to the users location can be automatically displayed. The latest news and sports scores can also be displayed with information specific to the user, e.g. local news instead of international, results relating to the Ottawa Senators instead of the Toronto Maple Leafs. The home page and the contents can also be dependent on the day and time, e.g. weather in the early morning, traffic in the late morning, and stock prices in the late afternoon. A live traffic report for the user's preferred route, including live traffic cameras, can also be displayed at the touch of a button or automatically at a predetermined time approximating the user's normal departure time. Each page can also include a GUI with a telephone link to initiate a telephone call to a person or business associated with the information displayed, e.g. the stock page can include the telephone number of the user's stock broker, the traffic report page can include the phone number of the user's office to let their boss know they will be late, the sports page can include the telephone number of a friend who is a fan of an opposing team or the same team, and the weather page can include the telephone number of the user's favourite golf course.

A link to Internet radio can also be provided, including a list of preferred radio stations. As above, the link can be established at the touch of a button or automatically according to the time of day or week, e.g. news radio in the early morning, sports in the late morning, music in the afternoon, and financial radio in the evening. Each radio station page, which is displayed on the display screen 16 when the radio station is selected by the user, can also include a GUI with the radio station's telephone number to initiate a telephone call to the radio station, e.g. in the event the station is a talk radio station or has a current phone in contest.

Each telephone display screen 16 can also be personalized to display a photo or a series of photos stored in memory, which is provided either on the server 14 or in the telephone processor 12. The photo or photos can be displayed all the time or whenever the telephone 1 goes into a inactive mode, i.e. no actions are currently being executed. The photo of a person initiating an incoming call or the subject of an outgoing call can be displayed on the display screen 16 when the call display functionality is linked to a specific photograph in memory.

Each homepage, which is downloaded from the server 14 or memory in processor 12 and displayed to the display screen 16, and links therefrom can also be based on the phone number of the telephone 1, i.e. the area code and/or the first three numbers in the exchange. In particular, advertising as defined hereinbefore, e.g. fast food, taxis, emergency numbers, automatically downloaded from the server 14 can be predetermined based on the telephone number of the telephone 1.

Links to pages related to outgoing calls can also be made, e.g. the time of day, location specific news or sports, local weather, and local weather forecasts can be displayed, based on the area code dialed.

Whenever the telephone 1 is in use, the processor 12 accesses an “on a call” page, which the API displays on display screen 16. The “on a call” page can include information about the person on the other end of the call, e.g. name, picture, duration of call, location and/or map based on area code of call. Furthermore, the “on a call” page can include links to the internet or other saved pages, including search engine pages, making the internet accessible during telephone conversations.

Telephone records of all the incoming and outgoing calls, including the person receiving or initiating the call, the call duration, long distance charges, can be saved in the memory provided with the processor 12 or on the server 14. If the telephone records are stored on the server 14, they can be accessed by persons having appropriate access thereto. Alternatively, the processor 12 can automatically e-mail the telephone records to designated personal on a timely basis, e.g. daily, weekly or monthly. In addition, the processor 12 can be programmed to email a designated person whenever a phone call is initiated or received by a given telephone 1. Moreover, phone messages left in the processor's memory can also be saved on the server 14 and/or forwarded by e-mail to a designated person, e.g. in MP3 format.

A family's weekly grocery list can be saved in the memory and displayed on the display screen 16 to enable additions, either by manual entry or by identifying the additional items from a list. The list can then be sent via e-mail, telephone, fax or the internet to a grocery store, where the order would be prepared for pick-up or delivery.

We claim:

1. A telephone comprising:
a telephone housing including a microphone, a speaker, a telephony service provider (TSP), telephone hardware for sending and receiving telephone calls, and a display screen;
a processor with memory for running a player, which utilizes a graphical page description language to display pages, including graphical user interfaces (GUIs) relating to telephone control, accessed from the internet or from content stored in memory on the display screen; and
an application programming interface (API) enabling the graphical user interfaces to interact with the TSP to control the telephone hardware for controlling the sending and receiving of telephone calls, whereby various combinations of telephone applications are displayable on the display screen and controllable therethrough.

2. The telephone according to claim 1, wherein the graphical page description language is hyper-text markup language (HTML).

3. The telephone according to claim 1, wherein the player comprises a commercially available web browser.

4. The telephone according to claim 1, further comprising a pre-processor for checking each page accessed by the player for a security feature, which ensures only desired pages are sent to approved phones and only approved phones will receive the desired pages.

5. The telephone according to claim 4, wherein the security feature is selected from the group consisting of a URL lock, a page signature, and an encryption.

6. The telephone according to claim 1, wherein one of the pages includes GUIs for digits 0 to 9 to enable a phone number to be dialed.

7. The telephone according to claim 1, wherein one or more of the pages includes GUIs with collections of data with corresponding phone numbers selected from the group consisting of incoming call history, outgoing call history, company directory and personal directory.

8. The telephone according to claim 7, wherein pressing on one of the GUIs on the screen initiates dialing the corresponding phone number.

9. The telephone according to claim 1, wherein the player enables a key word search to be performed, and the results thereof to be displayed in a page on the display screen including GUIs; and wherein pressing on one of the GUIs on the screen initiates dialing the corresponding phone number.

10. The telephone according to claim 1, wherein the processor and API displays a homepage on the display screen whenever the telephone is not in use, which is accessed from the internet or from the memory and includes contents with real-time information accessed from the internet and a telephone link related to the information for initiating a telephone call.

11. The telephone according to claim 10, wherein the contents of the homepage automatically changes based on temporal criteria.

12. The telephone according to claim 10, wherein the contents of the homepage and the telephone link are predefined by a user of the telephone.

13. The telephone according to claim 10, wherein the processor and API displays a “on a call” page on the display screen whenever the telephone is in use, which is accessed from the internet or from the memory and includes information relating to the telephone call.

14. The telephone according to claim 1, wherein a record of an incoming or an outgoing call is saved in the memory; and wherein the processor sends an e-mail to a predetermined e-mail address with information relating to the record.

15. A telephone system comprising:
a plurality of telephones according to claim 1; and
a centralized server for delivering a variety of different interactive advertisements from different advertisers, which automatically change dependent upon temporal criteria, to the telephones over the internet without request;
wherein each advertisement includes a graphic display for display on the display screen, and telephone functionality for making a telephone connection to a representative of the advertiser originating the advertisement.

16. The system according to claim 15, wherein the player interprets the advertisements and provides them to the display screen.

17. The system according to claim 15, wherein each graphic display provides a link to access further information about the advertiser.

18. The system according to claim 15, wherein the centralized server provides different advertisements to different telephones dependent upon geographic criteria.

19. The system according to claim 18, wherein the centralized server provides different advertisements to different telephones dependent upon which part of an urban area the telephones are located.

20. The system according to claim 18, wherein the centralized server provides different advertisements to different telephones dependent upon a telephone number corresponding to each telephone.

21. The system according to claim 18, wherein the centralized server provides different advertisements to different telephones dependent upon which hotel the telephones are located.

22. The system according to claim 18, wherein the centralized server provides different advertisements to different telephones dependent upon which rooms in a hotel the telephones are located.
